(19) United States
(12) Patent Application Publication
(10) Pub. No.: US 2011/0002191 A1
(43) Pub. Date: Jan. 6, 2011

(54) Active sonar apparatuses and methods

(75) Inventors: Martin Paul DeMaio, Ledyard, CT (US); John T. Green, Lisbon, CT (US); Larry Freeman, Potomac, MD (US); Donald T. Lerro, Colchester, CT (US); Atul R. Shah, Waterford, CT (US)

Correspondence Address: VENABLE LLP, P.O. BOX 34385, WASHINGTON, DC, 20043-9998, US

(73) Assignee: Alion Science & Technology, McLean, VA (US)

(21) Appl. No.: 12/000,097

(22) Filed: Dec. 7, 2007

Related U.S. Application Data
(60) Provisional application No. 60/873,275, filed on Dec. 7, 2006.

(51) Int. Cl. H04K 3/00; G01S 15/00

(52) U.S. Cl. 367/1; 367/87

(57) ABSTRACT

An active sonar detection system may include a transmitter, which may project into the transmissive medium signals of any frequency, amplitude or phase using one or more transducers. A transmit beamformer to provide transmission directionality may also be included. Generated transmit waveforms may have different temporal and frequency spectra that are adapted for different purposes. Such purposes may include, individually or in combination: detection of stationary or moving objects and surfaces and the ability to describe, classify and/or localize them; the ability to interrogate the environment for its reverberation and propagation features and/or to discern fronts and eddies; the ability to mislead third parties and their apparatuses either by making the transmitted signal unobtrusive, or provide for stealth operations by making the signals appear to be radiating from a source other than the one from which the signals are actually radiating, or by giving the signals or an object, such as a submarine, the appearance of having a purpose other than that for which they are actually intended.

### BACKGROUND

The following is applicable to detection systems and methods. More particularly, the following relates to active sound navigation and ranging (sonar) systems and methods in a maritime environment and will be described with a particular reference thereto. However, it is to be appreciated that the following is also applicable to acoustic detection systems in other transmissive environments.

An active sonar system typically includes four functional components: a transmitter, a receiver, a processing module and a display.

The transmitter may contain one or more transducers and may also contain a beamformer, power amplifiers, and a signal generator. The function of the transmitter is to convert electrical or mechanical energy into acoustic energy (a “sound wave”) in the water in a form dictated by the processor module.

The receiver may consist of one or more hydrophones formed into an array, and a signal conditioner. The function of the receiver is to convert sound in the water into an electrical signal that can be processed by the processor module. The received sound can at any time consist of signals transmitted by the sonar system, ocean noises, and echoes of the transmitted signal reflected from the target sought, ocean boundaries, and or other reflectors in the water.

The processor module functions to control the temporal, frequency, and spatial characteristics of the transmitted signal, to analyze the data provided by the Receiver, and to prepare the information extracted from that data for display to the operator. In particular, the receive data is analyzed to obtain the information that the operator is seeking; typically this includes such information as determining whether the sought after target is present (i.e. to “detect”), and if so, to determine the target's nature (i.e. to classify), location, course, and speed of advance. The time bandwidth product available in the echo to be processed plays a key role in the ability to detect and gain the information about the target; the greater the available time bandwidth product, the greater the information content of the sought after target echo.

The display functions to present to the operator the information that the processor module has garnered from the received data; it usually also provides a means to enable an operator to communicate commands to the system.

Active sonar system transmissions can be divided into two types; those that are pulsed and those that are continuous. Because sound is attenuated as it travels from the sonar to the target and back, transmitted signals are much louder than the echoes returned. To avoid the loud transmission interfering with, or jamming the echo, pulsed sonars stop transmitting in order to listen for the echo. Thus, although pulsed sonar may make full use of whatever bandwidth the system has available, they make relatively poor use of the search time available.

Continuously transmitting sonars seek to detect an acoustic echo even when the louder (continuous) transmission is present. In such systems different elements must be used for transmitting and receiving. In addition, continuous transmission necessitates a separation, such as in the frequency domain, between the transmitted signal and the received echo at any given time. One approach involves using transmissions such as Continuously Transmitted Frequency Modulation (CTFM) that continuously varies in frequency. As the path length, and therefore the travel time, from transmitter to target to receiver is always greater than that directly from transmitter to receiver, this assures that the echo frequency always lags the transmit frequency; therefore, a given transmitter frequency never arrives at the receiver at the same time that the same frequency arrives in the echo. This enables the high level transmitted signal to be continuously frequency filtered out of the received signal so as to avoid interfering with the lower level echo. However, because such systems rely on frequency separation, most of the available bandwidth, which could otherwise be used to improve echo detection and estimation, is essentially unused at any given moment in time.

An alternate continuously transmitting approach requires that the directivity of the transmitter, combined with baffling and spatial separation between transmitter and receiver, as well as stringent receiver side lobe suppression, be adequate to reduce the level of the directly transmitted signal at the receiver to such an extent that it is below the level of echo being sought. However, this requirement is so stringent that it precludes practical application of continuous wide band (WB) or pseudo random noise (PRN) transmissions in active search sonar systems.

Thus, while a pulsed active sonar may utilize the full available bandwidth, it can only partially use the available time. Conversely, a continuous active sonar based on frequency separation may use the full time it can only use a portion of the full available bandwidth at any time.

In addition, only a sonar capable of full bandwidth continuous transmission can detect objects while emulating the continuously radiated sounds of different ships and the full variety of other man made and naturally occurring sounds in the ocean. The ability to do this enables an active search sonar that does not readily alert third parties to the fact that a search sonar is being employed. This, in turn reduces both own platform vulnerability and the likelihood that sought after targets will take evasive action. Alternatively, spread spectrum techniques could be used to reduce the probability of transmission intercept. Here again, current sonars are constrained by the need to avoid any transmission that risks having the echo and the transmitted signal arrive at the Receiver at the same frequency and the same time.

There is thus a need for improved apparatuses and methods that overcome the above referenced problems and others.

### SUMMARY

An embodiment involves active sonar apparatuses and methods capable of enabling a sonar to continuously receive and analyze echoes while simultaneously transmitting a signal with any frequency content that the transmit subsystem is capable of. Furthermore, the described apparatus and method enables the system to discriminate between the transmitted signal and the echo reflected from the intended target(s) even when the energy from the transmitted signal at the receiver is many orders of magnitude greater than that of the echo and shares substantially, and even entirely, the same frequency content as the echo at the time both are present at the receiver.

The exemplary active sonar may also be capable of receiving and analyzing acoustic information from its surrounding environment while continuously transmitting a signal with any frequency content that the transmit subsystem is capable of and detecting the resulting echoes. In particular, the received data may be analyzed to obtain data such as high resolution time, frequency, and Doppler information that allows for continuous time varying and/or frequency varying observations of environmental phenomena such as multi-path, volume reverberation, boundary reverberation, ambient noise, bathymetry, wake effects, acoustic propagation variations, and any objects in the surroundings. This information may be then used to optimize in-situ sonar performance and/or related operational tactics.

### BRIEF DESCRIPTION OF THE DRAWINGS

The invention is described herein, by way of example only, with reference to the accompanying FIGURES, in which like components are designated by like reference numerals. The lead digit of each reference numeral is identified with the number of the FIGURE in which that component first appears.

FIG. 1 is a diagrammatic illustration of an active sonar detection system;

FIG. 2 is a diagrammatic illustration of a detailed portion of the active sonar detection system according to an exemplary embodiment of present invention;

FIG. 3 is a diagrammatic illustration of another detailed portion of the active sonar detection system according to an exemplary embodiment of present invention;

FIG. 4 is a diagrammatic illustration of another detailed portion of the active sonar detection system according to an exemplary embodiment of present invention;

FIG. 5 is a diagrammatic illustration of another detailed portion of the active sonar detection system according to an exemplary embodiment of present invention;

FIG. 6 is a diagrammatic illustration of another detailed portion of the active sonar detection system according to an exemplary embodiment of present invention;

FIG. 7 is a simulation example demonstrating the amount of interference rejection attainable as a function of interference level in the reference signal for broadband (PRN) continuous transmissions;

FIG. 8 demonstrates graphs of a before rejection signal and after rejection signal obtained in an in-water experiment;

FIG. 9 is an illustration of an example of the combined rejection and detection results for the in water experiment;

FIG. 10 shows a comparison of results from the in-water experiment and theoretical prediction corresponding to response after detection processing across Doppler channels;

FIG. 11 shows a comparison of the in-water results and theoretical prediction across correlation time delay cells; and

FIG. 12 show detection results of the in-water experiment with clipping at the receiver.

### DETAILED DESCRIPTION

A description of an active sonar apparatuses and methods capable of enabling a sonar to continuously receive, detect and/or analyze echoes while simultaneously transmitting a signal with any frequency content that the transmit subsystem is capable of is detailed below.

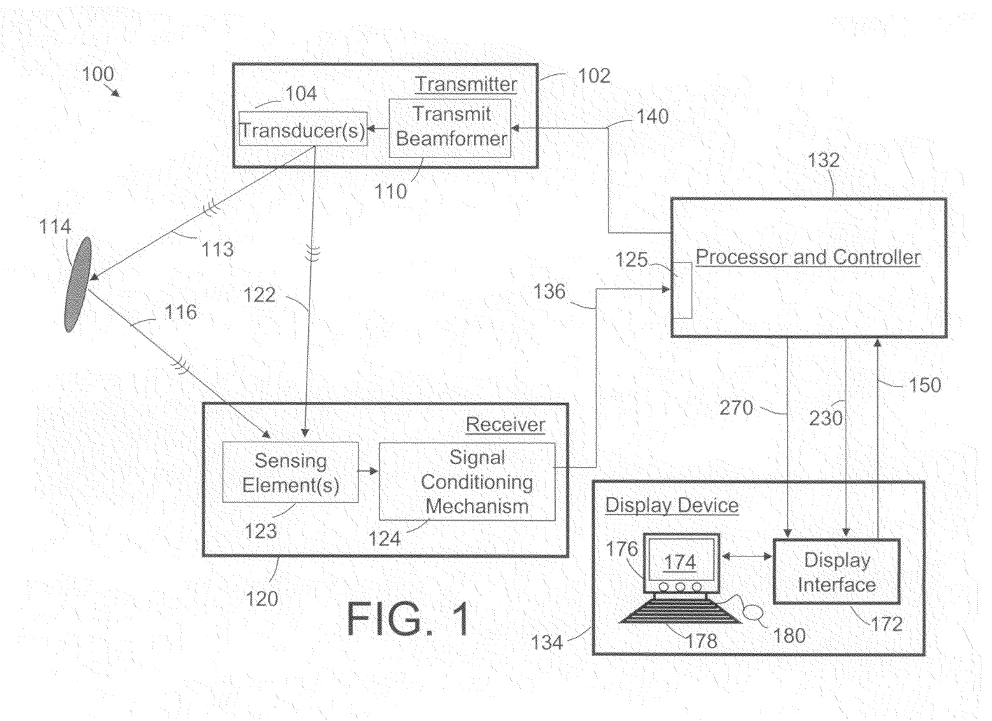

With reference to FIG. 1, an active sonar detection system 100 may include a transmitter 102, which may project into the transmissive medium signals of any frequency, amplitude or phase using one or more transducers 104. A transmit beamformer 110 to provide transmission directionality may also be included. Generated transmit waveforms 140 may have different temporal and frequency spectra that are adapted for different purposes. Such purposes may include, individually or in combination: detection of stationary or moving objects and surfaces and the ability to describe, classify and/or localize them; the ability to interrogate the environment for its reverberation and propagation features and/or to discern fronts and eddies; the ability to mislead third parties and their apparatuses either by making the transmitted signal unobtrusive, or by making it appear to be radiating from a source other than the one from which it is actually radiating, or by giving it the appearance of having a purpose other than that for which it is actually intended.

In one embodiment the transmit waveform 140 is produced from a separate controller or alternatively from a processing module 132. Examples of the generated waveforms and signals may include a continuous wave (CW) having a constant frequency, a frequency modulated (FM) waveform having a continuously varying frequency, a phase modulated (PM) waveform having continuously varying phase, a frequency shift keying (FSK) waveform having a varying frequency in discrete steps, a phase shift keying (PSK) waveform having a varying phase in discrete steps, a wide band random (WBR) waveform having all frequencies simultaneously with unpredictable non repeatable amplitude and phase relationships at any time, and a pseudo random noise (PRN) waveform having all frequencies simultaneously with predictable and repeatable amplitude and phase at any time. It is contemplated that the generated waveforms or signals may include any number of variations or combinations of the waveforms or signals described above or any other appropriate waveforms or signals appropriate to its purposes.

Although only one transmitter 102 is illustrated, it is contemplated that the detection system 100 described herein may simultaneously include two or more transmitters that may be co-located, using different frequencies, or separately located using the same or different frequencies and/or a combination of the above. The transmitted signal 113 may be reflected from a stationary or a moving reflector 114 as an acoustic echo or echoes 116 that may be sensed by a receiver 120. The transmitted signal may also travel directly to the receiver 120 where it may be present simultaneously with the received echo 116 and is denoted as a direct signal 122.

More particularly, the receiver 120 may include a sensing element or an array of sensing or receive elements 123, such as hydrophones or vector sensors, disposed spatially separated from the transmitting elements. The output of the sensing elements 123 may be preprocessed by a signal conditioning mechanism 124 to facilitate their further use by the system and may be combined in a beamformer that provides one or more spatially discriminating search beams. Some search beams may include the acoustic energy attributed to the echoes 116 which may correspond to the desired object or target reflection. The received search beams may also contain data corresponding to acoustic energy from other objects and/or undesired interferers such as, for example, a direct blast, (e.g., the direct signal 122), ocean noises, and reflections from own ship, ocean boundaries, or any other reflectors. The receiver 120 may provide directionality to enable determining the direction from which signals arrive and to suppress interference arriving from any other direction. Although only one receiver 120 is illustrated, it is contemplated that the detection system 100 may include two or more receivers that may be separately located.

A processor module 132 may control the temporal, frequency, and spatial characteristics of the transmitted signal, analyze the data provided by the receiver 120, and prepare the information extracted from the receive data for a display device 134. For example, the processing module 132 may analyze the output 136 from a receiver 120 to obtain the information based on a criteria or an inquiry provided by a user such as, for example, to determine whether the sought after target is present (i.e. to “detect”), and if so, to determine the target's nature (i.e. to classify), location, course, and speed of advance.

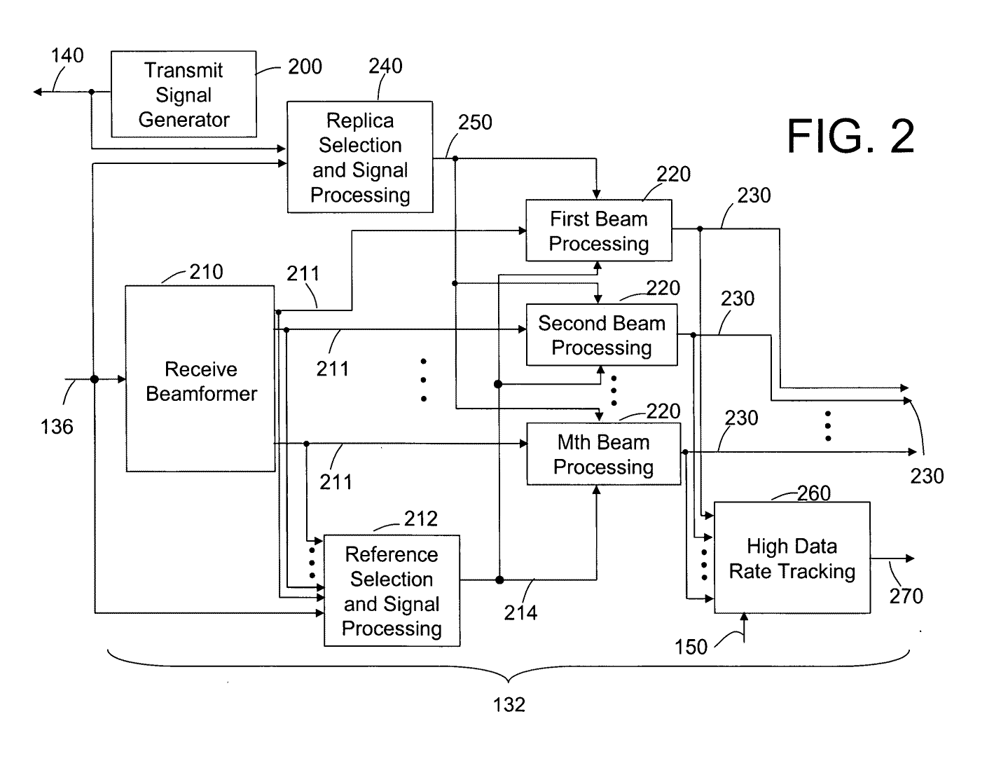

With continuing reference to FIG. 1 and further reference to FIG. 2, a signal conditioning mechanism 124 may receive one or more inputs and condition the received inputs for subsequent processing and output to a signal interface 125. In one embodiment, the receive beamformer 210 may be embodied within the processor module 132. In another embodiment, the receive beamformer 210 may be a component separate from the processing module 132. The receive beamformer 210 may form output 136 of the receiver 120 into beams that have desired directional discrimination properties.

In an exemplary embodiment, the beamformer 210 may apply a fixed or time-varying set of shading weights to its input signals 136 to attain a desired performance. This may include, for example, weighting such that one or more inputs are given a weight of zero, including the case where all but one input 136 is multiplied by zero and that a single element may be passed through unmodified.

In further embodiment, the receive beamformer 210 may include an adaptive beamformer which may adapt the receive beamformer's response automatically to different situations based on a predetermined criterion, such as, for example, minimizing the total noise output power. For example, the adaptive beamformer may weigh the receive signals adaptively, based on a combination of the information about the location of the hydrophones in space and the wave directions of interest with properties of the signals actually received by the receiver array to improve rejection of unwanted signals from other directions. This process may be carried out in the time or frequency domain.

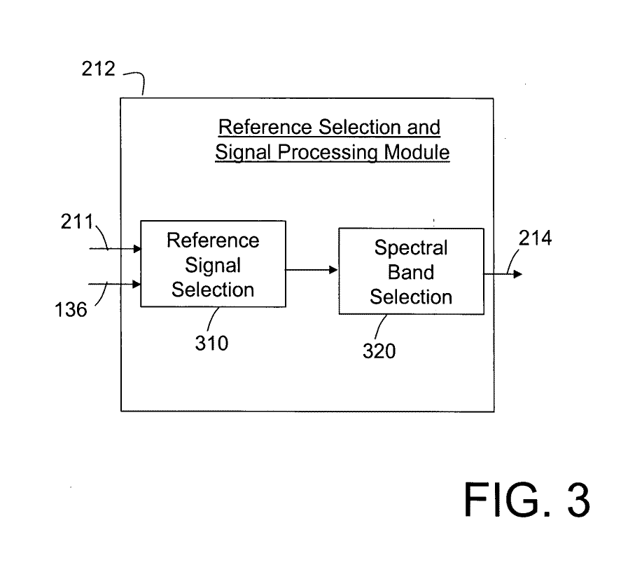

With reference to FIGS. 2 and 3, the search beams 211 from the receive beamformer 210 may be provided to the reference selection and signal processing function or module 212 which may output a reference signal 214 which may be used within the beam processing function or modules 220 for each of 1 to M search beams. Processing within the reference selection and signal processing function 212 may include a reference signal selection function or module 310 which may select one of the input beams 211 or 136 to be used as a reference within the beam processing function 220. The output of the reference signal selection function 310 may then be processed by the spectral band selection function or module 320 whose processing may include bandpass filtering, basebanding, and decimation to produce a reference signal 214 which then may be used by the beam processing function 220.

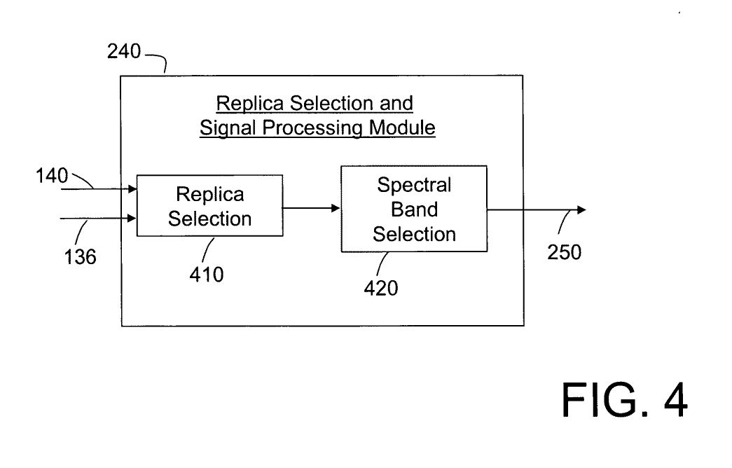

With reference to FIGS. 2 and 4, transmit waveform 140 and the signal conditioned receive data 136 may serve as inputs to the Replica Selection and Signal Processing function 240 which may output a replica signal 250 which may be used within the beam processing function 220 for each search beam. Processing within the Replica Selection and Signal Processing function or module 240 may include a Replica Selection function or module 410 to select which of its inputs (136 and 140) may be used as a replica for correlation within the beam processing function or module 220. The output of the Replica Selection function or module 410 may subsequently be processed by the Spectral Band Selection function or module 420 whose processing may include bandpass filtering, basebanding, and decimation to produce a replica signal 250 which then may be used in the beam processing function or module 220.

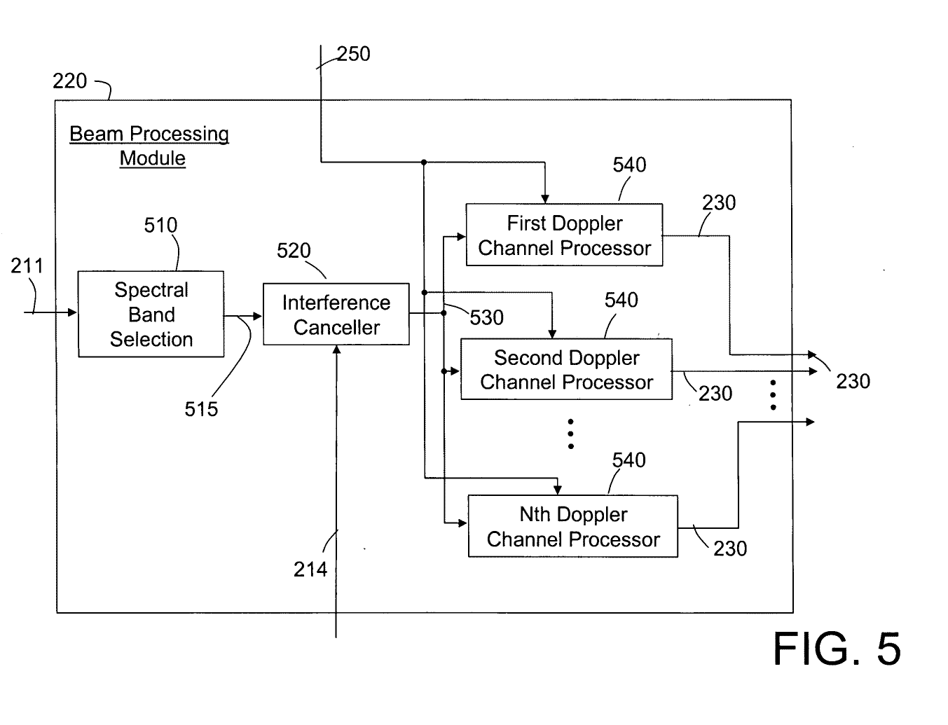

With reference to FIG. 2 and FIG. 5, the 1 to M search beams 211 from the receive beamformer 210 may be processed by the Spectral Band Selection function or module 510 whose processing may include bandpass filtering, basebanding, and decimation to produce basebanded decimated search beam time series 515 which then may be processed by the interference canceller function or module 520.

With continuing reference to FIGS. 2 and 5 and reference again to FIG. 1, the interference canceller 520, may remove the received energy attributed to the direct transmitted signal 122 from each received signal 515 of each search beam by appropriately utilizing the reference signal 214, using, for example, adaptive interference cancellation techniques known in the art. This produces the cleansed signal 530 to be used in the Doppler Channel Processor 540 for each Doppler channel of each search beam.

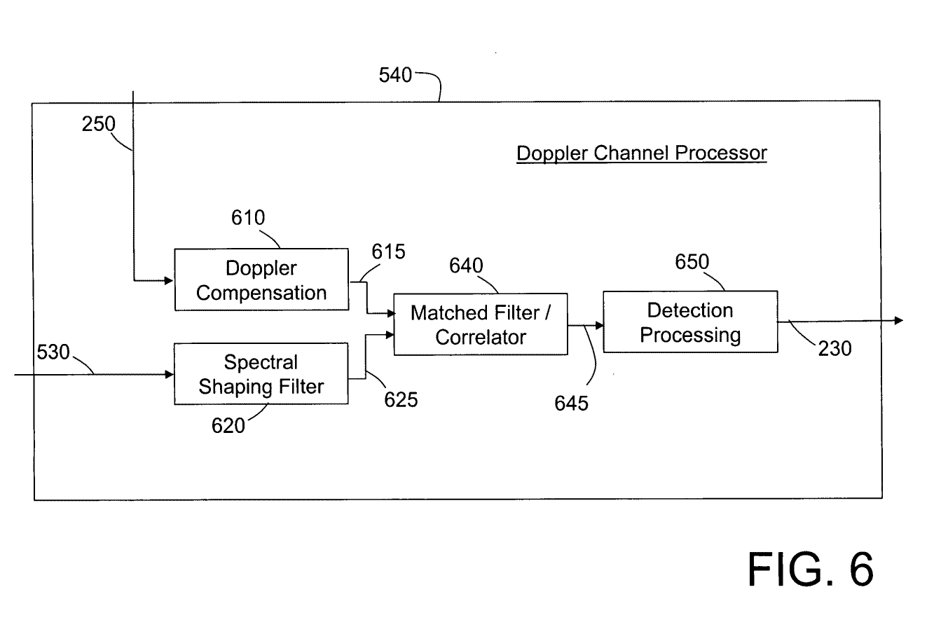

With continuing reference to FIGS. 2 and 5 and further reference to FIG. 6, a Doppler channel processor 540 may receive the replica signal 250 and the cleansed search beam 515 to process the data in each of a plurality of Doppler channels 540 for each search beam Doppler compensation 610 modifies the replica signal 250 to account for the time scaling hypothesized by the Doppler channel. Doppler Compensation 610 may consist of temporal compression (for a closing target) or dilation (for an opening target) of the replica signal 250 to output the Doppler compensated replica 615. The processing parameters depend on the Doppler assumption of the particular channel.

A Spectral Shaping Filter 620 is an optional function to pre-process the input cleansed search beam data 530 to produce a filtered beam time series 625 prior to correlation (matched filtering) 640 and detection processing 650. This Spectral Shaping Filter 620 may be used to perform a weighting of the strength of the response versus frequency to optimize detection performance.

The filtered search beam input 625 to the Matched Filter/Correlator 640 is the signal within which a target echo may or may not be present. The Doppler-compensated replica 615 is used to form the scan-varying matched filter 640 used for coherent detection. The Matched Filter/Correlator 640 block segments the input replica signal into scan-dependent matched filters which are applied to the input search beam on a per-scan basis. The segments may optionally be temporally overlapped as well as windowed temporally. The output for each beam and Doppler channel is a scan(time)-varying vector of complex correlogram/match filter data (vs. lag) which is provided to Detection Processing mechanism 650.

With continuing reference to FIG. 6 and further reference to FIG. 2 and FIG. 1, Detection Processing 650 may include incoherent (either magnitude or magnitude-squared) detection, temporal integration (optional), and normalization to prepare the correlogram/matched filter data for High Data Rate Tracking 260 and optionally to send to Display 134

With continuing reference to FIG. 2, High Data Rate Tracking 260 may include processing for data thresholding, clustering, energy tracking in range, bearing and range-rate (Doppler) space, and track management producing track data 270.

With reference to FIG. 1, the data may be passed along to a Display Interface 172 for processing and displaying on a display or displays 174 of a user interface station or stations 176. For example, processing within the Display Interface 172 may include ORing of acoustic detection data 230 across one or more of the following dimensions; time, Doppler, range and/or beam number, and subsequent re-quantization to form acoustic display formats. These formats may include standard formats used in the art such as BTR (bearing time response history), B-scan (detection data presented on a two dimensional range versus time history surface for multiple beams), or A-scan (detection amplitude versus range for individual beams). The Display Interface 172 may also be used to provide the information 150, such as control parameters, from a user to the processing module 132 via, for example, an input means such as a keyboard 178, a mouse 180, a joystick, microphone, touch screen, or any other appropriate input means. The display interface 172 communications with the user interface station 174 using 183.

With reference to FIG. 1, communication from High Data Rate Tracking 260 to Display 134 includes information about the trackers necessary to overlay the track information 270 on the display data. Communication 150 from Display 134 to High Data Rate Tracking 260, which may reside within processor module 132, may include sonar operator information provided via a display interface 172.

With reference to FIG. 1, the data may be passed along to the Display Interface 172 for processing and displaying on a display or displays 174 of a user interface station or stations 176. Processing within the Display Interface 172 may include ORing and requantization of acoustic detection data 230 to form acoustic grams, and overlaying of track data 270 on the grams. The Display Interface 172 may also be used to provide the information 150, such as control parameters, from a user to the processing module 132 via, for example, an input means such as a keyboard 178, a mouse 180, a joystick, microphone, touch screen, or any other appropriate input means.

With reference to FIG. 1, in one embodiment, the transmit signal generator 200 may be embodied within the processing module 132 so that the transmitted signal is known to the processing module 132 at all times.

It is contemplated that the transmitted signal may be interrupted from time to time as required to, for example, calibrate the system, measure the noise floor, check the workable condition of one or more hydrophones, reset the system or for any other appropriate operational condition.

The target 114 may be disposed partially or entirely underneath the ocean surface. The target may include a human, an animal, a ship, a submarine, and the like.

With reference to FIG. 1, it is contemplated that the Transmitter 102 and Receiver 120 may have fixed relative locations, for example when on the same platform (e.g. on the same ship) or may be separately dispersed.

Generally, to ensure that the receiver is not severely overloaded, the direct signal 122 acoustic level at the receiver may not substantially exceed a sum of the receiver's minimum detectable signal dictated by the acceptable sea noise floor and a dynamic range of the receiver. Linearity constraints of the receiver implies that the total received power level LR at the receiver is not significantly greater than a sum of a total noise power level NL and a dynamic range DR of the receiver and is given by a relationship:

LR not>>NL+DR (1A)

where
LR is the total power level at the receiver,
NL is the noise total power level, and
DR is the dynamic range of the receiver.

The total source power level LS is the integration of the source spectral level over the bandwidth B of the transmitted signal. In a worst case scenario for linearity of the receiver, if the signal has constant spectral level over the bandwidth:

LS=S_{B}+10 log(B) (1B)

where

LS is the source total power level in the direction of the target,

B is a processing bandwidth, and

S_{B} is a source spectral density level, Hz.

If the signal spectrum is dominated by tonals or CW waveforms that greatly exceeds the broad spectrum level, the source total power level LS is substantially equal to the power of the continuous wave SCW:

LS≈SCW (2)

The total received power level LR at the receiver is:

LR=LS−(TN+TL) not>>NL+DR; or (3)

where

LR is a total received power level at the receiver,

LS is a source total power level in the direction of the target,

TN is a transmit spatial null in the direction of the receiver, and

TL is a transmission power loss between the transmitter and the receiver.

Consider a system that includes a transmitter array designed to provide approximately 170 dB source level, SB, over a 1 kHz band, operated with a high dynamic range towed array capable of reception over the same frequency band. Thus, a signal that is flat over the band would yield LS=200 dB. Similarly if NB=40 dB, a flat noise spectrum would yield NL=70 dB over the band. A reasonable assumption for a high dynamic range receiver (i.e. one using a modern 24 bit A to D converter) is DR=110 dB. Assume the source and receiver separation is on the order of 300 Meters (˜1000 feet), so that TL=50 dB, then linearity constraint of equation (3) becomes

LR=200dB−50dB<70dB+110dB (4)

LR=150dB<180dB (5)

Thus, the constraint on the total received power LR may be easily satisfied. In the equations above, several of the used loss terms are conservative. For example, most bi-static or multi-static configurations involve transmission losses between transmitter and receiver of 60 dB to 80 dB vice the 50 dB value used here. Also note that there is no need for transmit null steering or baffles.

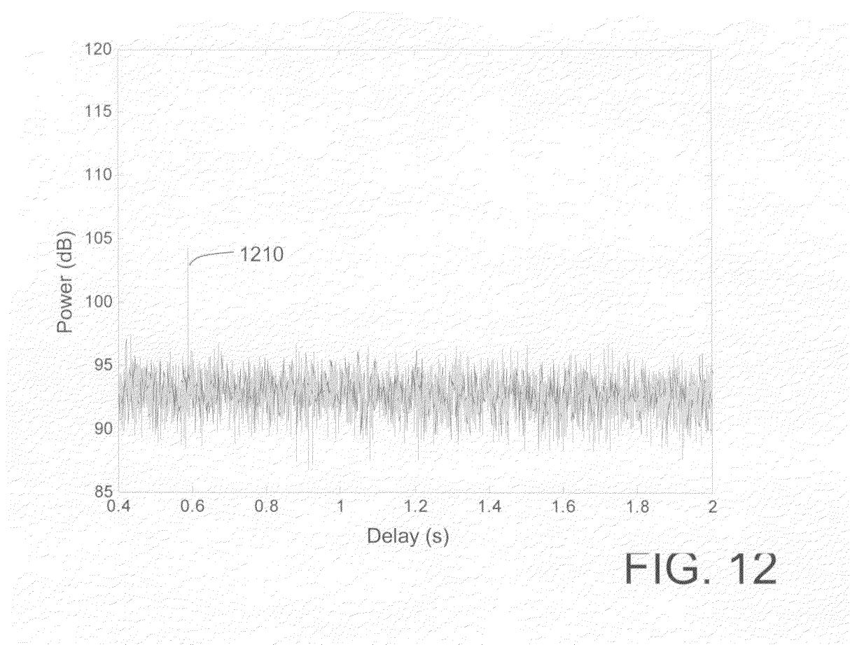

Perhaps more importantly, strict linearity of the receiver is not necessarily required for the rejection, the detection, and/or much of the analysis process to be effective as these functions can be implemented with processes that rely only on phase relationships. FIG. 12 shows the results of an in water continuously transmitting test where the receiver was deliberately reduced to 8 bits limiting the dynamic range and clipping the input signal by 12 dB; note that the target echo 1210 remains fully detected.

In a continuous transmission approach, the strong transmission at the receiver may mask the reception of target echoes of interest. Therefore, the receiver must be capable of sufficiently rejecting in at least one of the spatial or time domain, the transmitted signal, such that after the correlation processing the signal level substantially exceeds the effective noise floor (the combination of noise and any remaining direct blast energy) to ensure adequate detection performance in the receiver's search domain. E.g., the strong transmission may not mask the reception of echoes of interest.

The effective noise level floor is related to the received noise born in the transmissive medium NL and the directionality of noise NDI provided the receiver. The effective noise floor EN is:

EN=NL−NDI, (6)

where

NL is a noise total power level,

EN is the effective noise floor, and

NDI is the noise directionality provided by the receiver.

Transmit signal rejection at the receiver may be performed using spatial and time domain filtering/cancellation techniques. The high received level may be reduced using receiver spatial sidelobe suppression RSS and adaptive temporal broadband correlation rejection BR. Hence, the direct signal rejection requirement is:

LR−RSS−BR<EN, (7)

EN is the effective noise floor,

LR is a total received power level,

BR is the temporal broadband rejection, and

RSS is the side lobe suppression.

Continuing with the above example, a received level, LR=150 dB, while well within the dynamic range of the hypothetical system, would also be above the system minimum detectable level of the effective noise floor EN. Most recent receive arrays may provide directionality NDI as great as 25 dB. The effective noise floor EN defined in equation (6) is 45 dB. When such arrays are used and the known signals are rejected, the side lobe suppression RSS of 40 dB may readily be attained.

Broadband interference rejection techniques, such as a least mean square (LMS) adaptive filter, may provide rejection proportional to the interference level; thus a significant additional temporal rejection with BR=70 dB is achievable. Hence from equation (7), using LR=150 dB from equation (5):

150dB−40dB−70dB<45dB (8)

40dB<45dB (9)

As demonstrated by equation (9), the signal may be reduced to a level 5 dB lower than the background noise and the direct signal rejection criteria is met.

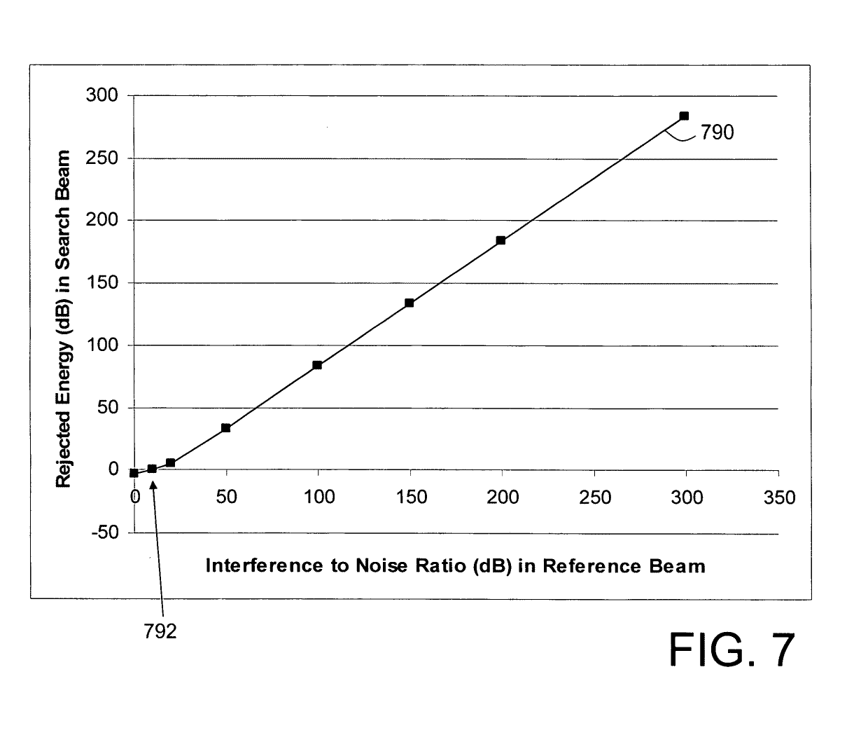

With continuing reference to FIG. 3 and further reference to FIG. 7, a simulation example is shown. A graph 790 demonstrates the amount of interference rejection attainable as a function of interference level in the reference signal for broadband (PRN) continuous transmissions. The simulation includes a reference signal time series including the sum of an interference time series and background ambient noise as well as a search beam time series including the sum of background ambient noise and interference leakage from the reference signal. The x-axis represents the interference to noise ratio in dB, which is the ratio of energy of the interference to the energy of the ambient noise in the reference signal 515. The y-axis represents an amount of interference energy rejected in the search beam by the interference canceller 520 which is, quantitatively, a ratio of the energy in the search beam before interference rejection to the energy in the search beam after interference rejection. As shown, for the interference to noise ratio greater than 20 dB, the amount of rejection attained is linearly proportional to the interference to noise ratio. More specifically, once the interference signal exceeds approximately 20 dB, illustrated as an area 192, the graph 190 demonstrates a one to one correspondence between every additional dB of interference to noise ratio in the reference signal and additional amount of attainable interference rejection in the search beam. E.g., the extent of rejections increases linearly with the extent of in the interference. Consequentially, given appropriate circumstances consistent with the simulation and sufficient interference to noise ratio, the net amount of interference energy remaining in the search beam after interference rejection is nominally independent of the interference level. The unwanted signal, as long as it is persistent, may be rejected to any required level without regard to its actual content in terms of frequency, amplitude & phase relationships.

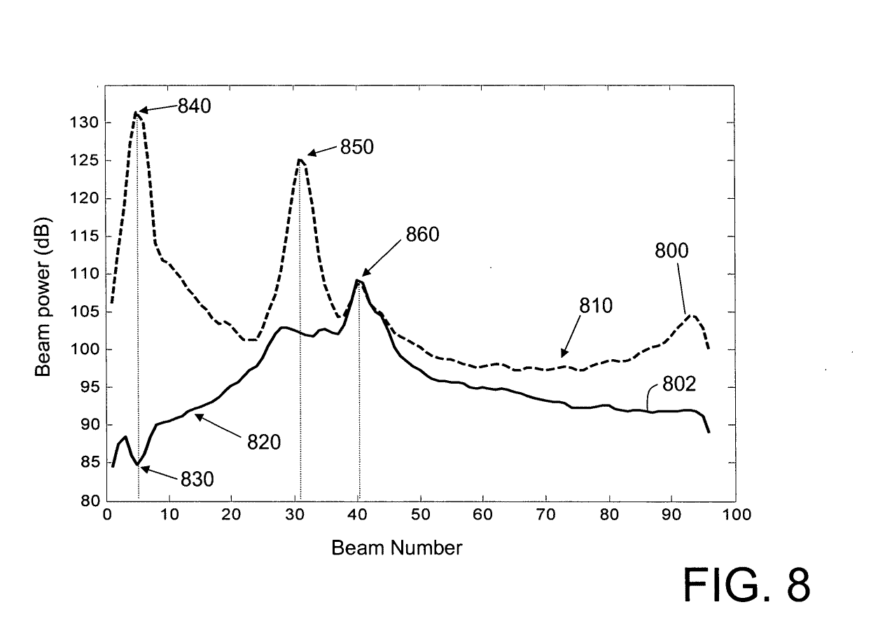

With reference to FIG. 8, the interference cancellation may be demonstrated by examining a before rejection signal graph 800 and after rejection signal graph 802 obtained in an in-water experiment. In the experiment, an omni-directional source and receive line array were placed at mid water column depth and separated by approximately 137 meters or 450 feet. The source level used in the experiment was 184 dB. The transmitted signal was a continuous PRN waveform with a bandwidth of 1300 Hz centered at 2150 Hz. The beamformer produced 96 conical beams with beam number 1 looking forward, e.g., 0° and beam number 96 pointing aft, e.g., 180°. A reference numeral 810 points to approximately 40 seconds time averaged power versus search beams numbers prior to the interference rejection. A reference numeral 820 points to time averaged energy across all beams after interference cancellation. The direct transmit signal shows as a peak 840 in the direction of beam number 5 and was used as the reference signal. Rejection of >40 dB occurs for beams pointing towards a signal transmitted from the source which shows as a peak 840. A peak 850 corresponds to a significant surface return which appears around beam number 32 which similarly shows significant rejection. Minimal rejection is seen in an area 860, about beam number 41, where multiple surface and bottom multi-path returns occur since they tend to be uncorrelated with the direct transmit signal. The extent of this uncorrelated multi-path interference arises from the relationship between the test receive array and the specific geometry of the body of water in which the test was conducted.

Finally, the received echo level can be detected above the noise and at the same time maintain a reasonable system false alarm rate. The passive broadband (PBB) detection equation (simplified by ignoring frequency dependent effects in propagation) requires

LS−TL_{1 way}+DI>NL+DT_{PBB} (10)

where
LS is a source total power level,
NL is the noise total power level,
TL_{1 way} is the one way transmission loss,
DT_{PBB} is the PBB detection threshold signal, and
DI is the directivity index of the receiver.

The PBB detection threshold DT_{PBB} is:

DT_{PBB}=5 log(d)−5 log(B)−5 log(T) (11)

where
DT_{PBB} is the PBB detection threshold signal,
d is a detection index,
B is a processing bandwidth,
T is the integration time.

The PBB detection threshold DT_{PBB} may be reduced by increasing the bandwidth B of the signal, and the time integration T. A detection index d is the required SNR to meet specific probabilities of false alarm and detection.

Equation (10) may be modified to yield an echo detection requirement:

LS−TL_{2 way}+TS>NL+DT−DI, (12)

where
LS is a source total power level in the direction of the target,
TL_{2way} is the two way transmission loss from the receiver to the target,
TS is the target strength of the reflected signal,
NL is the noise total power level at the receiver,
DT is the detection threshold signal, and
DI is the directivity index of the receiver.

Assuming fully coherent spectral/temporal processing, the detection threshold DT is:

DT=5 log(d)−5 log(B/B_{c})−5 log(T/T_{c})−10 log(T_{c})−10 log(B_{c}) (13)

where
DT is the detection threshold signal,
d is a detection index,
B is a processing bandwidth,
T is the integration time,
B_{c} is a coherent bandwidth,
T_{c} is a coherent integration time.

The detection threshold DT may assume a matched filter gain using a coherent bandwidth B_{c}. For broadband signal detection, with large time-bandwidth, using conservative estimates of signal coherence, the detection threshold DT may be equal to approximately −20 dB. Note by comparison that the DT for a pulsed sonar using this same bandwidth with 2 sec pulse length in a conventional FM transmit mode would be on the order of 10 dB; said otherwise the continuous full bandwidth approach offers a detection performance gain of about 30 dB. If the target strength, TS, of the reflected echo is 10 dB and that the two way propagation (out to the target and back to the receiver) is 180 dB, from equation (12):

200dB−180dB+10dB+25dB>70dB−20dB (14)

55dB>50dB (15)

Hence the echo level exceeds the detection level requirement by 5 dB.

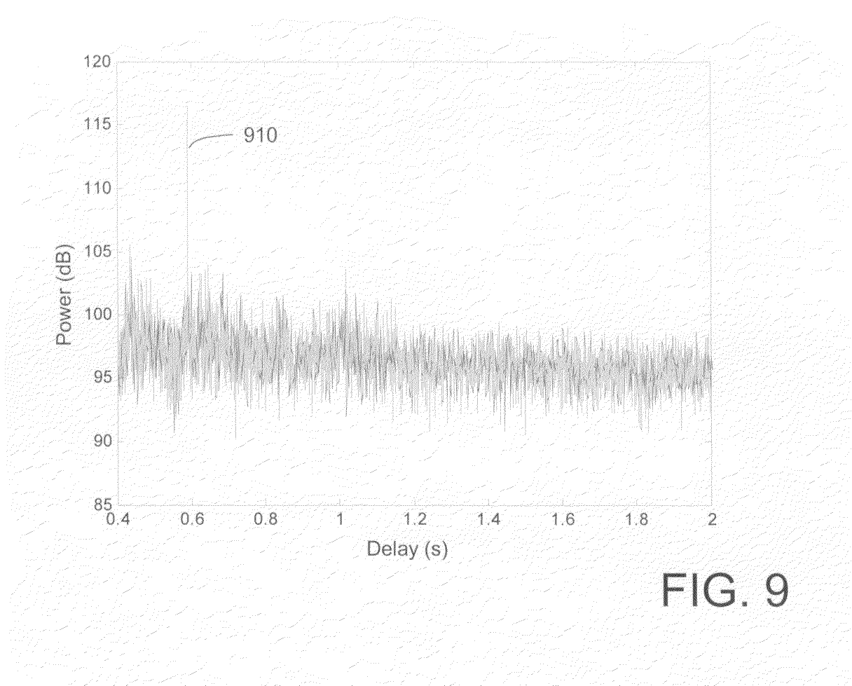

With reference to FIG. 9, an example of the combined rejection and detection results is illustrated for the in water experiment referenced above. The correlation processing utilized a coherent integration time (scan) of 3 sec. The average of 10 successive scans of the output of detection processing as a function of time delay. The particular example figure corresponds to the search beam containing the target under consideration. A reference numeral 910 indicates the correlation peak attributed to the target echo at a delay of approximately 0.59 sec; this echo peak which could not be discerned before the above correlation and averaging process, is now >15 dB above the background noise level and therefore easily detectable.

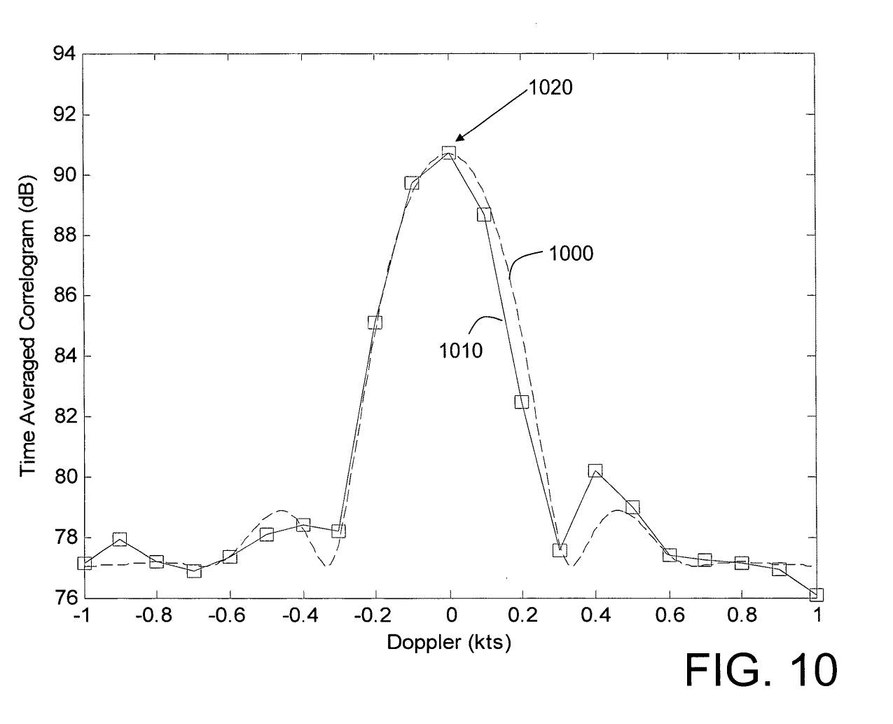

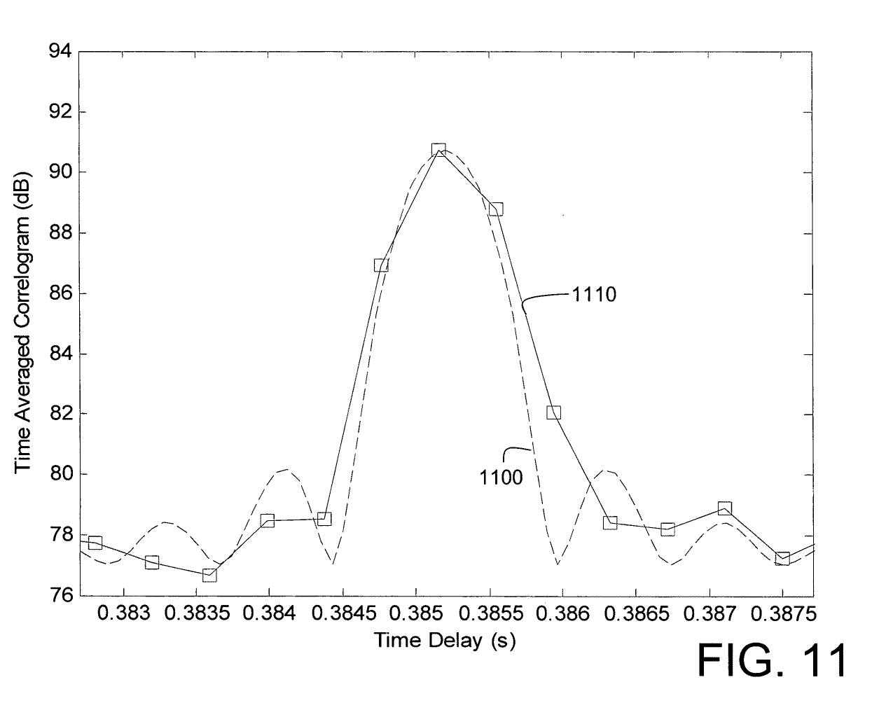

With reference to FIGS. 10 and 11, Doppler and time delay ambiguity is illustrated for the in-water test described above. The target for the particular example was located in beam number 78, and at a delay of approximately 0.385 sec. The source level for the transmission was 184 dB, and the correlation processing included a coherent integration time of 2 sec.

By a use of the apparatuses and methods described in this application, a full exploitation of both the time and frequency domains enables sonar performance that can be controlled after the receiver without modification of the transmit waveform. As an example, for any sonar its range/Doppler ambiguity function is a combination of its range error, which is nominally inversely proportional to its available bandwidth, and its Doppler error which is nominally inversely proportional to its coherent integration time. The detection processing 650 may, within limits of the systems' transmit bandwidth, easily manipulate, by digital filtering, that combination of coherent integration time and bandwidth which yields minimum ambiguity error without changing what it is transmitting, without having to make prior (and uncertain) estimates of what the optimum would be, and without compromising range accuracy for range rate accuracy. The processor module 132 may process continuously and optimally for two previously contradictory results—best range estimate and best range rate (i.e. Doppler) estimate without changing transmitted waveforms.

FIG. 10 shows a comparison of results from the in-water experiment to theoretical prediction corresponding to the matched filter response after detection processing across Doppler channels. The time averaged energy of the signals after the detection processing in the search beam and correlation time delay (equivalently range delay) cell corresponding to the target location is shown for the Doppler channels. The theoretical correlogram response versus Doppler is illustrated by a graph 1000. The theoretical correlogram response versus Doppler is illustrated by a graph 1000. The measured result from the in-water experiment is illustrated by a graph 1010. Note the close agreement between the theoretical and the measured results. As indicated by a reference numeral 1020, the Doppler channel corresponding to zero knots contains the most target energy, indicating a stationary target with a resolution of about 0.15 knots.

Similarly, FIG. 11 shows a comparison of the in-water results and theoretical prediction across correlation time delay cells, which in active sonar are equivalent to range cells which corresponds to approximately 0.34 msec or approximately 0.25 m resolution. The graphs show the time-averaged output of detection processing for the Doppler channel corresponding to zero knots. A graph 11000 illustrates the theoretical correlation response versus time delay. A graph 1110 illustrates the measured result from the in-water experiment. As illustrated, in FIGS. 10 and 11, the predicted and measured Doppler (equivalent to Range Rate) and time delay (or equivalently, range) ambiguity functions are consistent thus demonstrating the high resolution capability of the apparatus described in this application. Not only are these high resolutions far superior to that achievable with pulse or prior art frequency sweeping continuous type sonar's, but the capability to do so simultaneously from the same transmitted signal is unique to the apparatus and method described herein.

Many modifications and alternatives to the illustrative embodiments described above are possible without departing from the scope of the current invention, which is defined by the claims.

1. A method, comprising:
detecting an echo resulting from reflections of a continuously transmitted acoustic signal, which transmitted acoustic signal has any frequency, amplitude and/or phase characteristics versus time;
analyzing the echo to obtain a result; and
providing awareness of the echo and the result to a user.

2. The method according to claim 1, further comprising:
prior to detecting, receiving one or more outputs, each output including at least one of the transmitted acoustic signal or the echo;
canceling interference in each output caused by the transmitted acoustic signal; and
detecting and analyzing any echo that may be present in at least one of the outputs.

3. The method according to claim 2, wherein the analyzing further includes analyzing while continuing to detect, acoustic energy sensed by one or more elements or beams in such fashion as to be enable optimizing the active sonar's performance for specific environmental and operating conditions applicable at a time and place in which a sonar is being used.

4. The method according to claim 2 wherein the transmitted acoustic signal comprises a wide bandwidth transmit waveform and further comprising;
analyzing the echo to obtaining the result so that the result simultaneously provides a maximally achievable resolution of an estimated range to the reflector limited only by the bandwidth of the echo and a maximally achievable resolution of an estimated range rate of the reflector limited only by a rate of change of Doppler versus time.

5. The method according to claim 2, wherein the transmitted acoustic signal is designed to decoy or otherwise influence the behavior of other entities

6. The method according to claim 2, wherein the transmitted acoustic signal uses spread spectrum techniques to minimize the probability of it being intercepted and/or mimics one or more sounds otherwise occurring in the ocean so as to reduce the probability and/or extend a time it takes for the transmitted acoustic signals to be identified by a third party as emanating from an active sonar.

7. The method according to claim 2, further including:
receiving one or more outputs from one or more receivers;
canceling interference caused in the receiver outputs resulting from transmission from one or more transmitters to detect and analyze any echo sensed at each of the receivers, wherein the one or more receivers are one of co-located or separately located with the one or more transmitters; and
detecting and analyzing any echo sensed at each of the receivers.

8. The method according to claim 7, further including:
controlling the co-located or separately located transmitters so that one or more transmits a signal employing spread spectrum techniques to minimize a probability of the transmitted acoustic signals being intercepted and/or mimicking one or more sounds otherwise occurring in the ocean so as to reduce a probability and/or extend a time it takes for transmitted acoustic signals to be identified by a third party as emanating from an active sonar.

9. The method according to claim 7, further including:
controlling the co-located or separately located transmitters to transmit acoustic signals designed to decoy or otherwise influence other entities.

10. An apparatus, comprising:
a processing module to:
detect an echo resulting from reflections of a continuously transmitted acoustic signal, which transmitted acoustic signal has any frequency, amplitude and/or phase characteristics versus time;
analyze the echo to obtain a result; and
provide awareness of the echo and the result to a user.

11. The apparatus according to claim 10, wherein the processing module includes:
an interface to receive output from one or more receivers, each receiver output including at least one of the transmitted acoustic signal or the echo; and
an interference canceller to cancel interference in each receiver output caused by the transmitted acoustic signal so that any echo present in at least in one of the receiver outputs is detected and analyzed.

12. The apparatus according to claim 11, wherein the processing module further comprises a module to analyze, while continuing to detect, acoustic energy sensed by the one or more receivers in order to optimize an active sonar's performance for specific environmental and operating conditions applicable at a time and place in which the active sonar is being used.

13. The apparatus according to claim 11, wherein the transmitted acoustic signal includes a wide bandwidth transmit waveform and wherein the result simultaneously provides a maximally achievable resolution of an estimated range to a reflector limited only by a bandwidth of the echo and a maximally achievable resolution of an estimated range rate of the reflector limited only by a rate of change of Doppler versus time.

14. The apparatus according to claim 11, wherein the transmitted acoustic signal is designed to decoy or otherwise influence behavior of other entities.

15. The apparatus according to claim 11, wherein the transmitted acoustic signal uses spread spectrum techniques so as to minimize a probability of the transmitted acoustic signal being intercepted and/or mimics one or more sounds otherwise occurring in the ocean so as to reduce a probability and/or extends a time it takes for the transmitted signal to be identified by a third party as emanating from an active sonar.

16. The apparatus according to claim 11, wherein the interference canceller cancels interference caused in the receiver outputs resulting from transmission from one or more transmitters to detect and analyze any echo sensed at each of the receivers, wherein the one or more receivers are one of co-located or separately located with the one or more transmitters.

17. The apparatus according to claim 16 wherein the one or more transmitted acoustic signals uses spread spectrum techniques so as to minimize a probability of the transmitted acoustic signals being intercepted, and/or to generate signals mimicking one or more sounds otherwise occurring in the ocean so as to reduce the probability and/or extend the time it takes for the transmitted acoustic signals to be identified by a third party as emanating from an active search sonar,

18. The apparatus according to claim 15 wherein the one or more transmitted acoustic signals decoy or otherwise influence behavior of other entities.
